(19) United States
(12) Patent Application Publication
(10) Pub. No.: US 2018/0114459 A1
(43) Pub. Date: Apr. 26, 2018

(54) SHEET ASSEMBLY AND METHOD OF MANUFACTURING A SHEET ASSEMBLY

(71) Applicant: Mark M. Dwight, San Francisco, CA (US)

(72) Inventor: Mark M. Dwight, San Francisco, CA (US)

(21) Appl. No.: 15/793,162

(22) Filed: Oct. 25, 2017

Related U.S. Application Data
(60) Provisional application No. 62/412,944, filed on Oct. 26, 2016.

(51) Int. Cl. G09B 11/06; G09B 11/04; D21F 13/00

(52) U.S. Cl. CPC G09B 11/06; D21F 11/006; D21F 13/00; G09B 11/04

(57) ABSTRACT

A sheet assembly comprises a first grid comprising a first plurality of shapes on the sheet and a second grid comprising a second plurality of shapes on the sheet. The second plurality of shapes overlay the first plurality of shapes such that the second plurality of shapes are in a center of one or more squares defined by the first plurality of shapes. The first grid in combination with the second grid creates a template for the creation of one or more discrete components such as a list, a table, a chart and a graph. In some embodiments, the first grid comprises a plurality of crosshair shaped plus signs and the second grid comprises a plurality of dots. The two grid patterns are overlaid and offset from one another. The two patterns are offset such that the dots are located at the center of the squares defined by the crosshairs.

### RELATED APPLICATIONS

This Patent Application claims priority under 35 U.S.C. 119(e) of the the co-pending U.S. provisional patent application, Application No. 62/412,944, filed on Oct. 26, 2016, and entitled SHEET ASSEMBLY AND METHOD OF MANUFACTURING A SHEET ASSEMBLY”, which is hereby incorporated in its entirety by reference.

### FIELD OF THE INVENTION

The present invention is generally directed to sheet assemblies and methods of manufacturing sheet assemblies. More particularly, the present invention is directed to patterned sheets for writing lists, making notes, and drawing tables, charts, and graphs.

### BACKGROUND OF THE INVENTION

When creating lists, tables, charts and graphs it is helpful to have one or more grid-lined sheets to guide the creation of the lists, tables, charts, and graphs. It is desirable for such sheets to have uniformly positioned markings for horizontal and vertical orientation. Conventional graph paper has grids of horizontal and vertical solid lines. Dot grid paper has dots at the intersection points of invisible grid lines. In either case, the patterned sheets may not directionally guide the proper creation of the lists, tables, charts, and graphs. Additionally, graph paper and dot grid paper can be visually obtrusive and compete with a user's own writings and drawings.

### SUMMARY OF THE INVENTION

A sheet assembly comprises a first grid comprising a first plurality of shapes on the sheet and a second grid comprising a second plurality of shapes on the sheet. The second plurality of shapes overlay the first plurality of shapes such that the second plurality of shapes are in a center of one or more squares defined by the first plurality of shapes. The first grid in combination with the second grid creates a template for the creation of one or more discrete components such as a list, a table, a chart and a graph. In some embodiments, the first grid comprises a plurality of crosshair shaped plus signs and the second grid comprises a plurality of dots. The two grid patterns are overlaid and offset from one another. The two patterns are offset such that the dots are located at the center of the squares defined by the crosshairs.

In one aspect, a sheet assembly comprises a first grid pattern comprising a first plurality of shapes on the sheet, a second grid pattern comprising a second plurality of shapes on the sheet, wherein the second grid pattern overlays the first grid pattern such that the second plurality of shapes are in a center of one or more squares defined by the first plurality of shapes, wherein the first grid pattern in combination with the second grid pattern describes a template for one or more discrete journal components. In some embodiments, the first plurality of shapes comprise a plurality of plus signs arranged in a grid pattern. In some embodiments, the second plurality of shapes comprise a plurality of dots arranged in a grid pattern. In further embodiments, the first grid pattern overlays the second grid pattern such that the first plurality of shapes are in a center of one or more squares defined by the second plurality of shapes. In some embodiments, the one or more discrete journal components comprise one or more of a list, a bullet list, a table, a chart, and a graph. In some embodiments, the one or more discrete journal components comprise one or more of a journal event, a journal module, journal signifier, and a journal task. In some embodiments, the first grid pattern comprises a 0.25-inch plus sign grid pattern. In some of these embodiments, the second grid pattern comprises the dot grid pattern at the same pitch as the plus sign grid pattern and offset from the plus sign grid pattern by 0.125-inches.

In a another aspect, a method of manufacturing a sheet assembly comprises patterning a first grid comprising a first plurality of shapes on the sheet and patterning a second grid comprising a second plurality of shapes, wherein the second grid is patterned on the sheet such that it overlays the first grid pattern such that the second plurality of shapes are in a center of one or more squares defined by the first plurality of shapes, wherein the first grid pattern in combination with the second grid pattern describes a template for one or more discrete journal components. In some embodiments, the second patterned grid comprises a transparent sheet that is deposited onto the first patterned grid to form a composite sheet. In further embodiments, the first patterned grid comprises a first transparent sheet and the second patterned grid comprises a second transparent sheet that are combined to form the composite sheet. In some embodiments, the first plurality of shapes comprise a plurality of plus signs arranged in a grid pattern. In some embodiments, the second plurality of shapes comprise a plurality of dots arranged in a grid pattern. In some embodiments, the first grid pattern overlays the second grid pattern such that the first plurality of shapes are in a center of one or more squares defined by the second plurality of shapes. In some embodiments, the one or more discrete journal components comprise one or more of a list, a bullet list, a table, a chart, and a graph. In further embodiments, the one or more discrete journal components comprise one or more of a journal event, a journal module, journal signifier, and a journal task. In some embodiments, the first grid pattern comprises a 0.25-inch plus sign grid pattern. In some of these embodiments, the second grid pattern comprises the dot grid pattern at the same pitch as the plus sign grid pattern and offset from the plus sign grid pattern by 0.125-inches.

In a further aspect, a system for journaling comprises a plurality of sheets, each sheet comprising a plus sign grid pattern and a dot grid pattern overlaying the plus sign grid pattern at the same pitch but offset so the dots are in the center of the squares defined by the plus signs, wherein the plus sign grid pattern in combination with the dot grid pattern describes a template for one or more of a jounal event, a journal module, a journal signifier, and a journal task. In some embodiments, the plurality of sheets are arranged in one of a book and a binder. In some embodiments, the dot grid pattern comprises a transparent sheet that is deposited onto the plus sign grid pattern to form a composite sheet. In further embodiments, the plus sign grid pattern comprises a first transparent sheet and the dot grid pattern comprises a second transparent sheet that are combined to form the composite sheet. In some embodiments, the plus sign grid pattern comprises a 0.25-inch plus sign grid pattern. In some of these embodiments, the dot grid pattern comprises a same pitch as the plus sign grid pattern and offset from the plus sign grid pattern by 0.125-inches.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIGS. 1A-1D illustrate a sheet assembly comprising a second grid pattern overlaying a first grid pattern, in accordance with some embodiments.

FIG. 2 illustrates a method of manufacturing a sheet assembly, in accordance with some embodiments.

### DETAILED DESCRIPTION OF THE EMBODIMENTS

Embodiments of the invention are directed to a sheet assembly and method of manufacturing a sheet assembly. The sheet assembly comprises a first grid comprising a first plurality of shapes on the sheet and a second grid comprising a second plurality of shapes on the sheet. The second plurality of shapes overlay the first plurality of shapes such that the second plurality of shapes are in a center of one or more squares defined by the first plurality of shapes. The first grid in combination with the second grid creates a template for the creation of one or more discrete components such as a list, a table, a chart and a graph. In some embodiments, the first grid comprises a plurality of crosshair shaped plus signs and the second grid comprises a plurality of dots. The two grid patterns are overlaid and offset from one another. The two patterns are offset such that the dots are located at the center of the squares defined by the crosshairs.

Reference will now be made in detail to implementations of a sheet assembly and method of manufacturing the sheet assembly. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

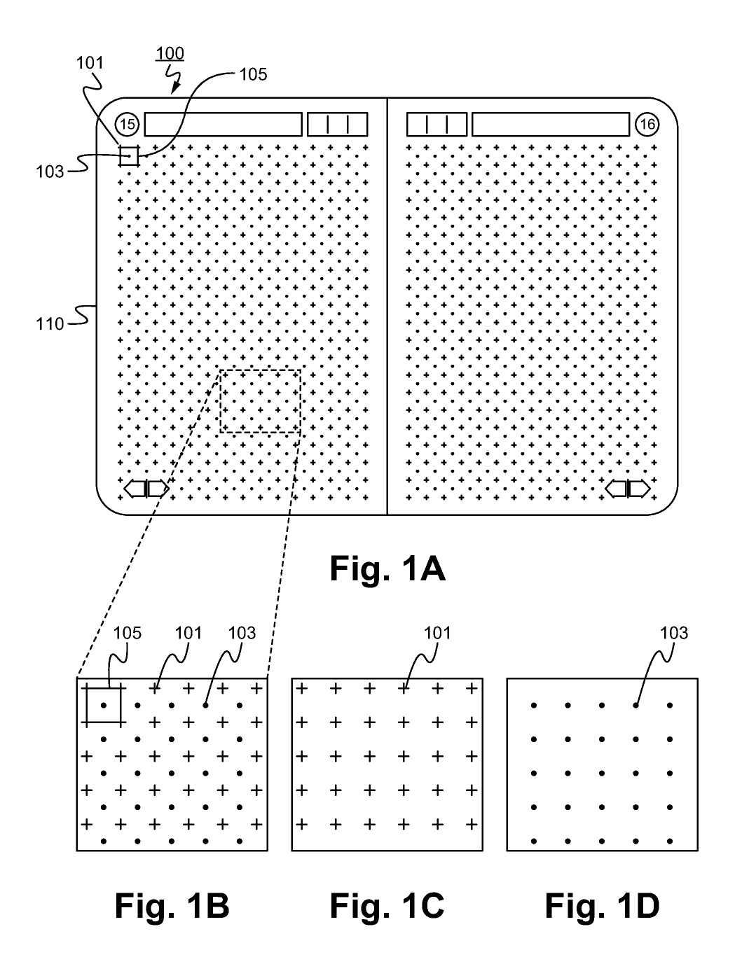

Referring now to FIG. 1A, a patterned sheet assembly is depicted therein. The patterned sheet assembly 100 comprises a first grid 101 comprising a first plurality of shapes on the sheet 100 and a second grid 103 comprising a second plurality of shapes on the sheet 100 overlaying the first grid 101 such that plurality of shapes of the second grid 103 are in a center of one or more squares 105 defined by the first plurality of shapes of the first grid 101. In some embodiments, the first plurality of shapes comprise a plurality of plus signs arranged to form the first grid 101 and the second plurality of shapes comprise a plurality of dots arranged to form the second grid 103. As stated above, the second plurality of shapes of the second grid 103 overlay the first plurality of shapes of the first grid 101 such that the second plurality of shapes 103 are in a center of a square 105 defined by the first plurality of shapes 101. The patterned sheet assembly 100 is able to comprise any appropriately desired number of shapes and configuration of shapes patterned on the sheet assembly 100. In some embodiments, a plurality of sheet assemblies 100 are able to bound within a book and/or a binder 110 for use.

FIG. 1B illustrates a closeup view of the patterned sheet assembly 100, such as described above. As described above, in some embodiments, the first grid 101 comprises a plurality of crosshair shaped plus signs and the second grid 103 comprises a plurality of dots. The two uniform grid patterns are overlaid and offset from one another. The two patterns are offset such that the dots are located at the center of the squares defined by the crosshairs. In some embodiments, the first grid pattern comprises a 0.25-inch plus sign grid pattern and the second grid pattern comprises a dot pattern at the same pitch but offset by 0.125-inch so the dots are in the center squares created by the plus signs.

As shown within FIGS. 1C and 1D, in some embodiments, the first grid 101 and the second grid 103 comprise separate patterned sheets. In these embodiments, the sheet assembly 100 is able to manufactured by depositing the second grid 103 onto the first grid 103 to create the overlaid plus and dot pattern, such that the sheet assembly 100 comprises a composite sheet. For example, in some embodiments, the first grid 101 and the second grid 103 comprise transparent sheets which are combined to form the composite sheet. Alternatively, in some embodiments, such as described above, the first grid 101 and the second grid 103 are able to be deposited onto the same sheet.

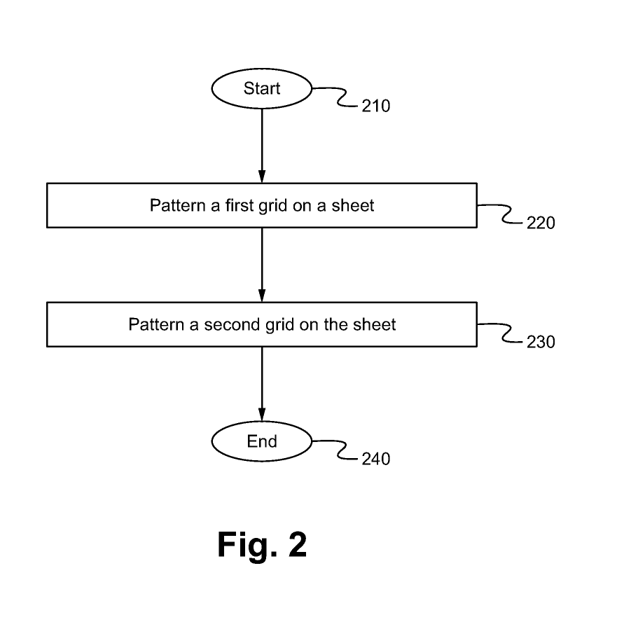

FIG. 2 illustrates a method of manufacturing a sheet assembly in accordance with some embodiments. The method begins in the step 210. In the step 220, a first grid comprising a first plurality of shapes is patterned on a sheet. In the step 230, a second grid comprising a second plurality of shapes is patterned on the sheet. The second grid is patterned on the sheet such that it overlays the first grid pattern such that the second plurality of shapes are in a center of one or more squares defined by the plurality of first shapes. The first grid pattern in combination with the second grid pattern describes a template for one or more discrete journal components. The method ends in the step 240.

In operation, the present invention addresses functional deficiencies of both solid line grids and dot grids. Solid line grids can be visually obtrusive and compete with the user's own writing and drawing. Dot grids can be visually disorienting since the dots themselves lack any directional features. Dots are also readily obliterated when a single line is drawn through a dot, so there is no way to accurately draw additional lines at other angles through the same dot, thereby making it difficult to accurately draw tables, charts and graphs.

The present invention comprises two uniform grid patterns overlaid and offset from one another. In some embodiments, the primary grid pattern is comprised of crosshair “plus signs”. The secondary grid pattern is comprised of dots. The two grid patterns are offset such that the dots are located at the center of the squares defined by the crosshairs. In some embodiments, each plus sign comprises two orthogonal hash marks of such length as to minimize visual clutter while not being completely obscured by the width of an ink or pencil line passing through their intersection. Unlike dots, drawing a line through a plus sign only obscures one crosshair, while the orthogonal crosshair remains exposed and maintains the spatial reference of their intersection. The horizontal and vertical dot and crosshair spacing is such that it is able to guide note taking, list making and freehand drawing of tables, charts and graphs, nominally 0.25 inch or 6 mm, which is the common line spacing for conventional lined paper and graph paper.

Particularly, the combination of dots and crosshairs is unique, and provides practical advantages over simple dot grids for combined note taking and freehand drawing of tables, charts and graphs. Crosshairs are less visually obtrusive than solid line grid patterns, while retaining horizontal and vertical guidance for writing and drawing. The offset dots allow precise bisecting of horizontal and vertical lines defined by the crosshairs with minimal visual clutter—a feature that is useful for making charts and plotting graphs. The dots also facilitate precise location of individual letters, numbers and symbols at the center of the square defined by the four surrounding plus signs—a useful feature for freehand drawing of checklists and bullet lists. As such, the sheet assembly the method of manufacturing a sheet assembly as described herein has many advantages.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A sheet assembly comprising:
a. a first grid pattern comprising a first plurality of shapes on the sheet;
b. a second grid pattern comprising a second plurality of shapes on the sheet, wherein the second grid pattern overlays the first grid pattern such that the second plurality of shapes are in a center of one or more squares defined by the first plurality of shapes, wherein the first grid pattern in combination with the second grid pattern describes a template for one or more discrete journal components.

2. The sheet assembly of claim 1, wherein the first plurality of shapes comprise a plurality of plus signs arranged in a grid pattern.

3. The sheet assembly of claim 1, wherein the second plurality of shapes comprise a plurality of dots arranged in a grid pattern.

4. The sheet assembly of claim 1, wherein the first grid pattern overlays the second grid pattern such that the first plurality of shapes are in a center of one or more squares defined by the second plurality of shapes.

5. The sheet assembly of claim 1, wherein the one or more discrete journal components comprise one or more of a list, a bullet list, a table, a chart, and a graph.

6. The sheet assembly of claim 1, wherein the one or more discrete journal components comprise one or more of a journal event, a journal module, journal signifier, and a journal task.

7. The sheet assembly of claim 1, wherein the first grid pattern comprises a 0.25-inch plus sign grid pattern.

8. The sheet assembly of claim 7, wherein the second grid pattern comprises the dot grid pattern at the same pitch as the plus sign grid pattern and offset from the plus sign grid pattern by 0.125-inches.

9. A method of manufacturing a sheet assembly comprising:
a. patterning a first grid comprising a first plurality of shapes on the sheet; and
b. patterning a second grid comprising a second plurality of shapes, wherein the second grid is patterned on the sheet such that it overlays the first grid pattern such that the second plurality of shapes are in a center of one or more squares defined by the first plurality of shapes, wherein the first grid pattern in combination with the second grid pattern describes a template for one or more discrete journal components.

10. The method of claim 9, wherein the second patterned grid comprises a transparent sheet that is deposited onto the first patterned grid to form a composite sheet.

11. The method of claim 9, wherein the first patterned grid comprises a first transparent sheet and the second patterned grid comprises a second transparent sheet that are combined to form the composite sheet.

12. The method of claim 9, wherein the first plurality of shapes comprise a plurality of plus signs arranged in a grid pattern.

13. The method of claim 9, wherein the second plurality of shapes comprise a plurality of dots arranged in a grid pattern.

14. The method of claim 9, wherein the first grid pattern overlays the second grid pattern such that the first plurality of shapes are in a center of one or more squares defined by the second plurality of shapes.

15. The method of claim 9, wherein the one or more discrete journal components comprise one or more of a list, a bullet list, a table, a chart, and a graph.

16. The method of claim 9, wherein the one or more discrete journal components comprise one or more of a journal event, a journal module, journal signifier, and a journal task.

17. The method of claim 9, wherein the first grid pattern comprises a 0.25-inch plus sign grid pattern.

18. The method of claim 17, wherein the second grid pattern comprises the dot grid pattern at the same pitch as the plus sign grid pattern and offset from the plus sign grid pattern by 0.125-inches.

19. A system for journaling comprising:
a. a plurality of sheets, each sheet comprising:
i. a plus sign grid pattern; and
ii. a dot grid pattern overlaying the plus sign grid pattern at the same pitch but offset so the dots are in the center of the squares defined by the plus signs, wherein the plus sign grid pattern in combination with the dot grid pattern describes a template for one or more of a jounal event, a journal module, a journal signifier, and a journal task.

20. The system of claim 19, wherein the plurality of sheets are arranged in one of a book and a binder.

21. The system of claim 19, wherein the dot grid pattern comprises a transparent sheet that is deposited onto the plus sign grid pattern to form a composite sheet.

22. The system of claim 19, wherein the plus sign grid pattern comprises a first transparent sheet and the dot grid pattern comprises a second transparent sheet that are combined to form the composite sheet.

23. The system of claim 19, wherein the plus sign grid pattern comprises a 0.25-inch plus sign grid pattern.

24. The system of claim 23, wherein the dot grid pattern comprises a same pitch as the plus sign grid pattern and offset from the plus sign grid pattern by 0.125-inches.
